(19) United States
(12) Patent Application Publication
(10) Pub. No.: US 2014/0270584 A1
(43) Pub. Date: Sep. 18, 2014

(54) RECLOSABLE PACKAGES AND METHODS OF MANUFACTURING

(71) Applicants: Ronald H. Exner, Icking (DE); Deborah A. Lyzenga, Long Valley, NJ (US); Jeffrey T. Weber, Lake Zurich, IL (US)

(72) Inventors: Ronald H. Exner, Icking (DE); Deborah A. Lyzenga, Long Valley, NJ (US); Jeffrey T. Weber, Lake Zurich, IL (US)

(21) Appl. No.: 13/829,323

(22) Filed: Mar. 14, 2013

(51) Int. Cl. B65D 33/20; B31B 1/26; B31B 1/25; B31B 1/90

(52) U.S. Cl. CPC B65D 33/20; B31B 1/90; B31B 1/26; B31B 1/25
USPC 383/61.1; 383/86; 493/213; 493/243; 493/264; 493/228

(57) ABSTRACT

A reclosable package has front and back panels each have a top end and a maximum height such that the maximum height of the back panel is greater than the maximum height of the front panel, resulting in an exposed segment of the back panel uncovered by the front panel. A closure flap including a first adhesive layer and a second adhesive layer and being non-removably attached to the exposed segment of the back panel via the first adhesive layer and removably attached to a portion of the front panel via the second adhesive layer. After opening to access an interior of the package, the second adhesive layer can be used to reattach the closure flap to the front panel. A method of manufacturing the package is also provided.

### FIELD

Reclosable packages and methods for their manufacture are described herein and, in particular, packages having adhesive-based reclosure features.

### BACKGROUND

Reclosable packages are used for a variety of food products (e.g., chewing gum sticks, chocolates, candy, and the like). Since consumers may not consume the food products in the packages in one serving, the packages can include reclosable features, such as mechanical fasteners or adhesive strips, to allow for reclosure of the packages.

Manufacture of reclosable packages having mechanical fasteners, such as interlocking fastener strips, can require additional manufacturing steps, which can undesirably add complexity and cost to the manufacturing process. Moreover, the cost of the mechanical fasters can undesirably increase the cost of the package.

Adhesive-based reclosable fasteners provide one alternative to the mechanical fasteners. For example, a reclosable flap may include an adhesive strip and may fold to cover a top opening of the package and attach to a wall of the package, which has a matching adhesive strip in alignment with the adhesive strip on the flap. Such arrangements where both the flap and the package wall include an adhesive strip can undesirably add cost and complexity to the manufacturing process. In addition, such reclosable packages can be manufactured such that the package material and the flap are formed from a single web of material and a multitude of fold lines and/or laser score lines are used to permit the flap to move from a closed position to an open position and vice versa. The incorporation of such fold lines and laser score lines can undesirably increase the complexity and cost of manufacturing of such packages, depending upon the configuration of the packages.

### SUMMARY

The flexible packages described herein can be advantageously manufactured without requiring the use of laser scoring or multiple fold lines. The packages are formed from two materials, such as films. A first material is folded to form the front and back panels of the flexible package and to define what will be a mouth or opening of the package. A second material having one or more strips of applied adhesive is attached to the first material such that the opening is covered. The second material can have a strip of relatively permanent adhesive for attachment to the back panel and a strip of reclosable adhesive for repeated attachment to the front panel to reclose the package after opening. The flexible packages described herein can be more cost-effective to manufacture than laser-scored packages because they can be manufactured without the use of laser machinery and do not require additional processing to create multiple fold lines.

In one form, a reclosable package comprises a flexible material forming opposed front and back panels connected via a bottom seal and a pair of end seals intersecting the bottom seal to bound at least a portion of a package interior. The front and back panels each have a top end and a maximum height defined by a distance from the top end to the bottom seal. The maximum height of the back panel is greater than the maximum height of the front panel such that there is an exposed segment of the back panel not covered by the front panel. The package further comprises a closure flap including a first adhesive layer and a second adhesive layer. The closure flap is non-removably attached to the exposed segment of the back panel via the first adhesive layer. The closure flap is removably attached to the front panel via the second adhesive layer.

Use of the terms “non-removably” and “removably” are relative, and apply to normal use. For example, it may be possible to separate the closure flap from the exposed segment of the back panel upon application of significant force, but can require more force, and in some circumstances several times the amount of force, to separate as compared to separating the closure flap from the front panel. During normal use, it is preferred that the closure flap will not separate from the exposed segment of the rear panel. Normal use can include an opening frequency corresponding to the number of items in the package, or a multiple thereof.

The closure flap can be movable from a closed position, where the second adhesive layer attaches the flap to the front panel, and an open position, where the flap is sufficiently unattached to the front panel such that access is provided to the package interior.

The first and second adhesive layers each can comprise an adhesive strip on an interior surface of the closure flap. The second adhesive layer can be a pressure sensitive material adapted to permit the closure flap to open to provide access to the package interior, and to reclose the package to restrict access to the package interior. The closure flap may further comprise a first non-adhesive area between the first and second adhesive layers, such that the first and second layers are spaced. The closure flap can include a top edge and a bottom edge and further comprises a second non-adhesive area between the second adhesive layer and the bottom edge of the closure flap. The second non-adhesive area can facilitate grasping of the flap by a user to move the closure flap from the first position to the second position.

The closure flap can optionally include a third adhesive layer, disposed on an opposite side of the second adhesive layer as compared to the first adhesive layer, adapted to seal a portion of the closure flap to the front panel of the package. The closure flap can include at least one line of weakness configured to permit the closure flap to divide into a remainder portion adhered to the front panel using the third adhesive layer and a moveable portion selectively attachable to the front panel using the second adhesive layer, with the first adhesively layer non-removably attaching the moveable portion to the exposed segment of the rear panel.

The reclosable package described herein can be in combination with a food product in the interior of the package.

Methods of forming the above-described packages include: directing a first web of material in a machine direction; placing at least one food product onto the first web of material; folding opposing longitudinal edges of the first web of material inward over adjacent portions of the first web of material and around the food product and bringing the opposing longitudinal edges of the first web of material toward each other to a position where folded inward opposing longitudinal edges of the first web of material are offset from a central longitudinal axis of the first web of material such that a gap is formed between the folded inward opposing longitudinal edges of the first web of material; applying a second web of material including at least the first and second adhesive layers to the first web of material such that the first adhesive layer non-removably attaches to the first web of material in the gap between the folded inward opposing longitudinal edges and the second adhesive layer removably attaches to a folded over portion of the first web of material proximate the folded inward opposing longitudinal edges of the first web of material; forming the pair of end seals; and separating the package from a remainder of the first web of material and the second web of material.

The separating of the package can include cutting through the first web of material and the second web of material along the central longitudinal axis of the first web of material. The separating of the package may further include cutting through at least one of the end seals.

### BRIEF DESCRIPTION OF THE DRAWINGS

FIG. 1 illustrates a perspective front view of an exemplary reclosable flexible package in a closed position;

FIG. 2 illustrates a perspective front view of the reclosable flexible package of FIG. 1 in a partially open position and showing an access opening;

FIG. 3 illustrates a side elevational view of the reclosable flexible package of FIG. 1 in cross-section taken along lines 3-3 in FIG. 1;

FIG. 4 illustrates a perspective side view of relevant portions of an exemplary process for manufacturing the reclosable flexible package of FIG. 1;

FIG. 5A illustrates a cross-section of a film substrate that can be used to provide the closure flap of the reclosable flexible package of FIG. 1;

FIG. 5B illustrates a cross-section of an alternative film substrate that can be used to provide a closure flap of a reclosable flexible package similar to that of FIG. 1

FIG. 6 illustrates a perspective front view of another exemplary reclosable flexible package in a closed position;

FIG. 7 illustrates a perspective front view of the reclosable flexible package of FIG. 6 with a removable portion being partially separated from the remainder of the closure flap during the opening of the package;

FIG. 8 illustrates a side elevational view of the reclosable flexible package of FIG. 6 in cross-section taken along lines 8-8 in FIG. 6;

FIG. 9A illustrates a cross-section of a film substrate that can be used to provide the closure flap of the reclosable flexible package of FIG. 6; and

FIG. 9B illustrates a cross-section of an alternative film substrate that can be used to provide a closure flap of a reclosable flexible package similar to that of FIG. 6.

### DETAILED DESCRIPTION

An exemplary reclosable flexible package as described herein includes front and back panels formed from a folded flexible substrate, such as film or paper, with an attached, unfolded closure flap formed from a pressure sensitive tape or a heat sealable film or other substrate and including a strip of pressure sensitive adhesive (“PSA”) or the like disposed thereon. The closure flap can be removably attached to one of the panels via the PSA strip to both seal the package and provide an open/reclose feature for the package such that the package can be easily opened and reclosed while maintaining package integrity. The closure flap can be non-removably attached to a second panel via a relatively permanent adhesive to permit the closure flap to move between the open and closed positions without being detached from the second panel. The closure flap can include a non-adhesive area below the PSA strip to facilitate easy opening of the package and easy reclose/reseal of the package when needed.

With reference to FIGS. 1-3 an exemplary form of a reclosable flexible package 100 is shown. The package 100 can be formed from a flexible film substrate 202 (see FIG. 4) and includes a front panel 104, a back panel 106, and a closure flap 108 attached to the front and back panels 104 and 106, as will be described in more detail below. The front panel 104 has an interior surface 105 and an exterior surface 107, and the back panel 106 has an interior surface 109 and an exterior surface 111, as shown in FIG. 3. A package interior 113 is defined at least in part between the interior surfaces 105 and 109 of the front and back panels 104 and 106, respectively. The package interior 113 of the package 100 can be used to store gum sticks, candy, chocolates, or other food products, as well as non-food products.

The front and back panels 104 and 106 of the package 100 are formed from a continuous film substrate (e.g., substrate 202 of FIG. 4) configured such that a fold in a transition between the front and back panels 104 and 106 forms a bottom portion which functions as a bottom seal 110 of the package 100, as shown in FIGS. 1-3. The back panel 106 has a maximum height defined by a distance from the bottom seal 110 to a top edge 115 of the back panel 106. In the form depicted in FIG. 3, the top edge 115 of the back panel 106 defines a top end of the package 100. The front panel 104 has a maximum height defined by a distance from the bottom seal 110 to a top edge 117 of the front panel 104. As shown in FIG. 3, the maximum height of the back panel 106 is greater than the maximum height of the front panel 104. As such, the top edge 115 of the back panel 106 is further away from the bottom seal 110 than the top edge 117 of the front panel 104 and the package 100 generally forms a J-shape when viewed from a side as in FIG. 3. Although depicted as a fold, the bottom seal 110 can take other forms, such as a heat seal between the front and back panels 104 and 106, including if such panels are formed from separate webs or sheets of material.

The front and back panels 104 and 106 are attached at their peripheral side edge portions 112 and 114 via two side seals 116 and 118, respectively. The side seals 116 and 118 can be formed via laminating, heat sealing, or attaching via an adhesive the side edge portions 112 and 114 of the front and back panels 104 and 106 to each other to form the interior 113 of the package 100.

In the form depicted in FIGS. 1-3, the closure flap 108 is generally rectangular and has an exterior surface 119, an interior surface 121, opposite side edges 123 and 125, a top end 127, and a bottom end 129. Instead of being rectangular, the closure flap 108 can be of any other suitable shape depending on a particular package, for example, trapezoidal, triangular, circular, oval, or the like. The closure flap 108 may be formed from a pressure sensitive tape, a heat-sealable film including a pressure sensitive adhesive (“PSA”), a film, paper or other substrate having a strip of adhesive, including a PSA, or the like.

A first adhesive layer 122 is disposed on the interior surface 121 of the closure flap 108 proximate the top end 125 of the closure flap 108 for creating a permanent attachment between the closure flap 108 and the interior surface 109 of the back panel 106 of the package 100, as shown in FIG. 3. The first adhesive layer 122 permits the closure flap 108 to be permanently or non-removably attached to a portion of the back panel 106 of the package 100. The adhesive layer 122 may be in the form of a strip including a permanent adhesive material. The permanent adhesive material may be formed from a single material or combinations of materials. For purposes of this application, the terms “permanent” and “non-removable,” when used with reference to the attachment between the closure flaps (e.g., 108 and 508) and one of the front and back panels (e.g., 104, 504 and 106, 506) of the packages (e.g., 100 and 500), will be understood to mean that the portion of the closure flap that is “permanently” or “non-removably” attached (e.g., via a permanent adhesive) is not meant to be detached from the respective portion of the front panel or back panel of the package during normal use.

The first adhesive layer 122 extends continuously from one side edge 123 of the closure flap 108 to the other side edge 125 of the closure flap 108, as shown in FIGS. 1 and 2. It is to be appreciated that the first adhesive layer 122 can extend across a portion of the distance between the side edges 123 and 125 and that the first adhesive layer 122 may also have one or more discontinuous portions.

The interior surface 121 of the closure flap 108 includes a second adhesive layer 124 disposed thereon proximate the bottom end 129 of the closure flap 108 for creating a non-permanent or removable attachment between the closure flap 108 and the exterior surface 107 of the front panel 104, as can be seen in FIGS. 1-3. For purposes of this application, the terms “non-permanent” and “removable,” when used with reference to the attachment between the closure flaps (e.g., 108 and 508) and one of the front and back panels (e.g., 104, 106 and 504, 506) of the packages (e.g., 100 and 500), will be understood to mean that the portion of the closure flap that is “non-permanently” or “removably” attached (e.g., via a pressure sensitive adhesive) is meant to be detached from the respective portion of the front panel or back panel in normal use, for example, when opening the package to gain access to the food products stored in the package interior (e.g., 113 and 513).

The second adhesive layer 124 extends continuously from one side edge 123 of the closure flap 108 to the other side edge 125 of the closure flap 108, as depicted in FIGS. 1 and 2. It is to be appreciated that the second adhesive layer 124 can extend across a portion of the distance between the side edges 123 and 125 and that the second adhesive layer 124 may also have one or more discontinuous portions.

The second adhesive layer 124 may be in the form of a strip including a PSA that permits the opening of the closure flap 108 to provide access to the package interior 113 and reclosing of the closure flap 108 to restrict access to the package interior 113, and optionally, to hermetically seal the package 100. The PSA of the second adhesive layer 124 can be a UV-cured PSA. Instead of a PSA strip, the second adhesive layer 124 may include any other type of material that provides for the removable attachment of the closure flap 108 to a portion of the front panel 104 (and optionally, the back panel 106) of the package 100. The materials comprising the second adhesive layer 124 are preferably chosen such that the second adhesive layer 124 can remain attached to the closure flap 108 and the exterior surface 107 of the front panel 104 of the package 100, even after multiple openings and reclosures of the package 100. The second adhesive layer 124 is preferably selected from materials that are neutral or non-reactive to the product (e.g., food) contained in the package interior 113. In one approach, the second adhesive layer 124 is configured to provide a reclosable seal even in abnormally cold and/or abnormally hot conditions. For example, the second adhesive layer 124 can include one or more materials effective to maintain the closure flap 108 attached and the package 100 in a closed condition and/or sealed in a temperature range of about −10° C. to about 90° C.

The closure flap 108 includes a first adhesive-free or non-adhesive area 126 positioned at least in part between a bottom edge of the first adhesive layer 122 and a top edge of the second adhesive layer 124, as depicted in FIGS. 1-3. For purposes of this application, the terms “adhesive-free area” and “non-adhesive area” will be understood to mean those areas of the closure flaps (e.g., 108 or 508) that are not meant to attach to the front panel (e.g., 104 or 504) or the back panel (e.g., 106 or 506). The first non-adhesive area 126 at least in part overlies the package interior 113, as shown in FIG. 3, and allows for the package 100 to be flipped upside down without the contents thereof (e.g., gum sticks, candy, or the like) sticking to the interior surface 121 of the closure flap 108.

The closure flap 108 further includes a second adhesive-free or non-adhesive area 128. In the illustrated form, the second non-adhesive area 128 is positioned at least in part between a bottom edge of the second adhesive layer 124 and the bottom edge 129 of the closure flap 108. In one approach, the second non-adhesive area 128 forms a pull tab that permits a user to move the closure flap 108 in upward and/or downward directions for opening and reclosing the package 100.

The closure flap 108 is movable from a first (closed or sealed condition) position where the first adhesive layer 122 is attached to a portion of the back panel 106 and the second adhesive layer 124 is attached to a portion of the front panel 104, toward a second (open condition) position where the first adhesive layer 122 remains attached to the portion of the back panel 106, but the second adhesive layer 124 is spaced away from the portion of the front panel 104 to provide the user access to the package interior 113 through the access opening 130. When moving between the first and second positions, the closure flap 108 can pivot about an area when the first adhesive layer 122 is attached to the back panel 106.

To open the package 100, a user can grasp the closure flap 108 (e.g., at the second non-adhesive area 128) and pull the closure flap 108 in an upward direction to expose an access opening 130, as shown in FIG. 2, to gain access to gum sticks or other products stored in the package interior 113. To reclose the package 100, for example, after removing one or more gum sticks or other products, the user can grasp the closure flap 108 (e.g., at the second non-adhesive area 128) and pull the closure flap 108 in a downward direction to bring the second adhesive area 124 into contact with the exterior surface 107 of the front panel 104 to reattach the second adhesive layer 124 of the closure flap 108 to the front panel 104 and restrict access to the access opening 130 (and, optionally, hermetically seal the package 100). In one approach, to reclose the package 100, the user may be required to press (e.g., with a thumb) on the exterior surface 119 of the closure flap 108 after the second adhesive layer 124 is in contact with the exterior surface 107 of the front panel 104 to securely reattach the closure flap 108 to the front panel 104.

It is to be appreciated that the relative dimensions of the first adhesive layer 122, second adhesive layer 124, and first and second non-adhesive areas 126 and 128 have been shown for illustration purposes only, and may be varied to accommodate various package sizes. Further, it is to be appreciated that while the closure flap 108 has been shown with two adhesive layers 122 and 124 and two non-adhesive areas 126 and 128, it is to be appreciated that the closure flap 108 can be formed with three, four, or more adhesive layers, with three, four, or more non-adhesive areas, or without one or both of the adhesive-free areas 126 and 128.

In one form, there may be no gap between the first and second adhesive layers 122 and 124, and the second adhesive layer 124 may continuously extend to the bottom edge 129 of the closure flap 108. In another form, the dimensions of the first adhesive layer 122 may remain unchanged and the second adhesive layer may be dimensioned such that it is approximately equal to the combined dimension of the second adhesive layer 124 and the non-adhesive areas 126 and 128 illustrated in FIG. 1. In yet another form, the dimensions of the first adhesive layer 122 and the non-adhesive area 128 may remain unchanged and the second adhesive layer may be dimensioned such that it is approximately equal to the combined dimension of the second adhesive layer 124 and the non-adhesive area 126 illustrated in FIG. 1. In yet another approach, the first adhesive layer 122 may have a greater dimension in a direction toward the bottom edge 129 of the closure flap 108 such that the first adhesive layer 122 would replace at least a portion of the first non-adhesive area 126

While FIGS. 1-3 show the package 100 as having two panels 104 and 106 and a single closure flap 108, it will be appreciated that the package 100 can be constructed in a variety of configurations and include a number of panels other than two (for example, 3, 4, 5, 6, or more). Similarly, while the package 100 has been shown in the form of a rectangular pouch, other non-rectangular configurations of the package 100 are also contemplated. The package 100 can be manufactured from materials including, but not limited to, polymer laminate films, as well as, paper, paperboard, paper poly-foil laminate, coated polymers, coated paper (e.g., wax paper), and the like, and combinations thereof. Although the reclosable package 100 is described herein as usable for food product and chewing gum applications, the package 100, and other packages (e.g., package 500) contemplated in this disclosure, can also be used in non-food applications, such as medical, pharmaceutical, and industrial package applications.

Methods of manufacturing the package 100 can use heat seals, cold seals, extrusion and adhesive lamination, or co-extrusion. Generally, when food products such as gum sticks are enveloped and sealed within a first film substrate that will form the front and back panels 104 and 106 of the package 100, a second layer of film substrate that will form the closure flap 108 is attached to the first film substrate, and the first and second film substrates are then cut into individual packages 100. One exemplary method of manufacturing the package 100 is generally shown in FIG. 4.

A film substrate 202 is unwound from a feed roll 200 and is directed in a machine direction, as shown in FIG. 4. As the film substrate 202 is unwound from the feed roll 200, the gum sticks 400 and 402 are positioned on a surface of the first film substrate 202, as shown in FIG. 4, and opposite longitudinal ends 204 and 206 of the film substrate 202 are folded inward and brought toward each other to envelope the gum sticks 400 and 402. The opposite ends 204 and 206 of the film substrate 202 are brought toward each until they form folded inward edges 208 and 210 that are in proximity to a central longitudinal axis (shown as a dashed line in FIG. 4) of the film substrate 202.

The folded inward edges 208 and 210 are offset from the central longitudinal axis such that a gap 212 is formed between the folded inward edges 208 and 210, as depicted in FIG. 4. As such, the film substrate 202 is maintained as a single layer of film in the gap 212, unlike adjacent portions of the film substrate 202 that have a second layer of the film substrate 202 folded over them. More specifically, portions of the film substrate 202 between the folded inward edges 208 and 210 and the opposite longitudinal ends 204 and 206, respectively, are folded over adjacent portions of the film substrate 202 and positioned such that the film substrate 202 forms the front and back panels 104 and 106 of the package 100 in a J-like shape as shown in FIG. 3.

A second feed roll 300 including a second film substrate 302 is positioned above (or in any other suitable orientation) over portions of the first film substrate 202 having folded inward edges 208 and 210, and the second film substrate 302 is applied onto the first film substrate 202.

The second film substrate 302 includes a first adhesive layer 322, a pair of first non-adhesive areas 326 adjoining the first adhesive layer 322 on each side, a pair of second adhesive layers 324 adjoining the first non-adhesive areas 326, and a pair of second non-adhesive areas 328 adjoining the second adhesive layers 324, as seen in FIGS. 4 and 5A. As discussed above, the relative sizes and positions of the first adhesive layer 322, first non-adhesive areas 326, second adhesive layers 324, and second non-adhesive areas 328 of the film substrate 302 have been shown for illustration purposes only and can be varied to accommodate a wide variety of package shapes and sizes.

As the longitudinal edges 204 and 206 of the first film substrate 202 are folded inward toward each other to form the folded inward edges 208 and 210 such that portions of the film substrate 202 generally assume a double J-shape, the second film substrate 302 is applied on top of the film substrate 202 such that the first adhesive layer 322 is attached to the film substrate 202 in the gap 212, and the second adhesive layers 324 are attached over a respective one of the folded inward edges 208 and 210. The portions of the second film substrate 302, when attached to the respective portions of the first film substrate 202 (which will form front and back panels 104 and 106 of the package 100), form the closure flap 108 of the package 100.

After the attachment of the portion of the second film substrate 302 that will form the closure flap 108, the food products 400 and 402 become fully contained within the film substrates 202 and 302 and a pair of end seals (e.g., seals 116 and 118) can be formed using, for example, using one or more sealing jaws to seal the first film substrate 202 and the second film substrate 302. The end seals can be formed, for example, via heat sealing, lamination, or fusion of appropriate portions of the first and second film substrates 202 and 302.

Finally, the packages 100 are singulated from the remainder of the first and second film substrates 202 and 302. For example, cutting devices can make one or more cuts though the first film substrate 202 and the film substrate 302 to singulate the individual packages 100. The cuts can include a cut in the central longitudinal axis of the materials, extending in the machine direction, as well as transverse cuts relative to the machine direction. This method advantageously allows the package 100 to be formed without having to use laser scoring, multiple fold lines, or other potentially complex techniques.

Turning to further details of the second film substrate 302, and with reference to FIG. 5A, the substrate 302 can optionally be configured for a variety of reclose properties. For example, the surface of the substrate 302 with second adhesive layers 324 have a coating such that the adhesive layer 324 has a greater affinity for adhesion to the front panel 104 of the package 100 as compared to the substrate 302. This can result in a package 100 where the second adhesive layer will largely transfer upon initial use to the front panel 104. In other words, the majority or substantially all of the adhesive will remain attached to the front panel 104 when the closure flap 108 is initially opened. Advantageously, this can position the adhesive of the second adhesive layer 324 out of the path of removal of a product from within the package 100. The opposite affinity for adhesive can also be obtained by configuring the front panel 104 to have a lesser affinity for adhesion as compared to the surface of the substrate 302 with second adhesive layers 324. This can be done through the use of coatings, such as silicon base coatings or adhesive deadeners, on the front panel 104, either side of the second substrate 302, and on either side of the second adhesive layer 324, as well as combinations thereof.

Furthermore, it can be advantageous to have the surface of the second substrate 302 on an opposite side from the second adhesive layer 324 have a lesser affinity for adhesion as compared to the surface of the second substrate 302 to which the second adhesive layer 324 is attached. This is because when the substrate 302, with the second adhesive layer 324 thereon, is wound in the roll 300, it is desirable to have the second adhesive layer 324 remain on the surface to which it was originally applied as opposed to transferring to the opposite surface when unwound. Alternatively, a removable liner could be used to restrict the second adhesive layer 324 from transferring during unwinding. Depending upon the properties of the first adhesive layer 322, the same concerns can be addressed in the same manner for the first adhesive layer 322.

Although the second substrate 302 is described and illustrated in FIG. 5A as having non-adhesive areas 326 and 328 in the form of gaps between the first and second adhesive layers 322 and 324 and adjacent ends of the substrate 302, respectively, the non-adhesive areas 326 and 328 could be in the form of fillers 338 and 340, as shown in FIG. 5B. The fillers 338 and 340 could either be deadened zones of a common adhesive layer forming the first and second adhesive layers 322 and 324, such as by use of a coating or the like, or, in the case of actual gaps, could be a non-adhesive material that fills the gap, or a combination thereof. Having a more constant thickness can advantageously facilitate manufacturing the package, such as by contributing to improved tensioning of the second substrate 302 during unwind and application to the first substrate 202. The various reclose and adhesion properties discussed above with respect to the embodiment of FIG. 5A can be incorporated into the embodiment of FIG. 5B.

The package 500 illustrated in FIGS. 6-8 is similar to the package 100 described with reference to FIGS. 1-3, but includes a closure flap 508 that is different from the closure flap 108 of the package 100. Specifically, the closure flap 508 of the package 500 is similar to the closure flap 108 of the package 100, but additionally includes a third adhesive layer adapted to non-removably attach a portion of the closure flap 508 to a portion of the front panel 504 to provide a tamper-evident feature for the package 500, as will be described in more detail below. The front and back panels 504 and 506 of the package 500 are identical to the front and back panels 104 and 106 of the package 100 and will not be separately described. For ease of reference, in FIGS. 6-8, the aspects of the package 500 that are similar to the aspects of the package 100 have been designated with like reference numbers, but with the use of a leading “5” instead of a “1.”

The closure flap 508 is similar to the closure flap 108 in that it includes first and second adhesive layers 522 and 524 and the first and second non-adhesive areas 526 and 528, which are identical to the first and second adhesive layers 122 and 124 and the first and second non-adhesive areas 126 and 128 of the closure flap 108, as shown in FIGS. 6-8. Unlike the closure flap 108 of the package 100, the closure flap 508 of the package 500 includes a third adhesive layer 530 disposed on the interior surface 521 of the closure flap 508.

The third adhesive layer is disposed proximate the bottom end 529 of the closure flap 508 for sealing the package 500 and creating a permanent or non-removable attachment between the closure flap 508 and the exterior surface 107 of the front panel 504, as illustrated in FIG. 8. The closure flap 530 further includes a third non-adhesive area 532 extending from a bottom edge of the third adhesive layer 530 to the bottom edge 529 of the closure flap 508. The third non-adhesive area 532 may form a pull tab that facilitates use a user to remove the closure flap 508 from the front panel 504 and to separate the second adhesive layer 530 from the remainder of the closure flap 508, as will be discussed in more detail below.

The third adhesive layer 530 extends continuously from one side edge 523 of the closure flap 508 to the other side edge 525 of the closure flap 508, as depicted in FIGS. 6 and 7. It is to be appreciated that the third adhesive layer 530 can extend across a portion of the distance between the side edges 523 and 525 and that the third adhesive layer 530 may also have one or more discontinuous portions. The third adhesive layer 530 can be formed from the same material or materials as the first adhesive layer 524. Alternatively, the third adhesive layer 530 may be formed from other materials such as those identified above.

When the package 500 is in a sealed or closed condition, the third adhesive layer 530 is attached to the exterior surface 507 of the front panel 504 to seal (e.g., hermetically) the package 500, as shown in FIGS. 6 and 8. The third adhesive layer 530 is non-removably attached to the front panel 504 of the package 500. The closure flap 508 includes a remainder portion 540, which includes the third non-adhesive area 532 and the third adhesive layer 530, as depicted in FIG. 7. The remainder portion 540 is separable from a moveable portion of the closure flap 508 along a line of weakness, such as a score line 534. The score line 534 can include a starter notch 536 aligned with the score line 534 to facilitate separation by the user. The score lines 534 in the closure flap 508 can be formed by a laser (e.g., a carbon dioxide laser), or may be formed by other suitable techniques, for example, die-cutting or micro-abrasion. To initially open the package 500, a user can tear along the score line 534 to separate the closure flap 508 into the movable portion and the remainder portion 540. A tear line can then be formed which follows along a path delineated by the score lines 534. With the remainder portion 540 separated from the closure flap 508 and remaining adhered to the front panel, the package 500 remains in a closed condition due to the attachment of the second adhesive layer 524 to the front panel 504.

After the separation of the closure flap 508 along the score line 534, a user can grasp the closure flap 508 (e.g., at the second non-adhesive area 528 or the second adhesive layer 524) and pull the closure flap 508 in an upward direction to expose an access opening, substantially as shown in FIG. 2, to gain access to gum sticks or other products stored in the package interior 513. To reclose the package 500, for example, after removing one or more gum sticks or other products, the user can grasp the closure flap 508 (e.g., at the second non-adhesive area 528) and pull the closure flap 508 in a downward direction to bring the second adhesive area 524 into contact with the exterior surface 507 of the front panel 504 to reattach the second adhesive layer 524 of the closure flap 508 to the front panel 504. Optionally, depending on the material forming the second adhesive layer 524, the user may be required to press (e.g., with a thumb) on the exterior surface 519 of the closure flap 508 after the second adhesive layer 524 is in contact with the exterior surface 507 of the front panel 504 to securely (and removably) reattach the closure flap 508 to the front panel 504.

FIG. 9A is analogous to FIG. 5A, but depicts a film substrate 602 that may be used in a manufacturing process as shown in FIG. 4 to form the package 500 with the closure flap 508. More specifically, to manufacture the package 500 instead of the package 100 in FIG. 4, instead of the film substrate 302, the film substrate 602 would be applied to the film substrate 202 to form the closure flap 508 instead of the closure flap 108. All other steps of the method would remain the same and are discussed above with reference to FIG. 4. The film substrate 602 of FIG. 9A can be configured to have the various reclose and adhesion properties discussed above with respect to the second substrate 302 of FIG. 5 discussed above. Likewise, the use of fillers 638, 640, and 642 or adhesively-deadened zones of common or coextensive adhesives can be used to provide a more constant thickness, as shown in FIG. 9B. The various reclose and adhesion properties discussed above with respect to the embodiment of FIG. 5A can be incorporated into the embodiment of FIG. 9B.

It is to be appreciated that the relative dimensions of the first, second, and third adhesive layers 522, 524, and 530 and the first, second, and third non-adhesive areas 526, 528, and 532 of the closure flap 508 have been shown in FIGS. 6-9 for illustration purposes only, and may be varied to accommodate various package sizes. Further, it is to be appreciated that while the closure flap 508 has been shown with a remainder portion 540 that includes the third adhesive layer 530 and the third non-adhesive area 532, the separable portion 540 of the closure flap 540 may be formed without the third non-adhesive area 532 such that the third adhesive layer 530 would extend to the bottom edge 529 of the closure flap 508.

While preferred embodiments have been described in detail, variations and modifications can be effected within the configurations described herein.

1. A reclosable flexible package, the package comprising:
a flexible material forming opposed front and back panels connected via a bottom seal and a pair of end seals intersecting the bottom seal to bound at least a portion of a package interior, the front and back panels each having a top end and a maximum height defined by a distance from the top end to the bottom seal, the maximum height of the back panel being greater than the maximum height of the front panel such that there is an exposed segment of the back panel not covered by the front panel; and
a closure flap including a first adhesive layer and a second adhesive layer, the closure flap being non-removably attached to the exposed segment of the back panel via the first adhesive layer and removably attached to the front panel via the second adhesive layer.

2. The package according to claim 1, wherein the closure flap is movable from a closed position, where the second adhesive layer attaches the flap to the front panel, and an open position, where the flap is sufficiently unattached to the front panel such that access is provided to the package interior.

3. The package according to any one of claims 1 and 2, wherein the first and second adhesive layers each comprise an adhesive strip on common side of the closure flap.

4. The package according to any one of claims 1-3, wherein the closure flap further comprises a non-adhesive area between the first and second adhesive layers.

5. The package according to any one of claims 1-4, wherein the closure flap includes an adhesive free starter portion between the second adhesive layer and a bottom edge of the closure flap opposite the first adhesive layer.

6. The package according to any one of claims 1-5, wherein the closure flap includes a third adhesive layer non-removably attached to the front panel of the package, the third adhesive layer being disposed on an opposite side of the second adhesive layer from the first adhesive layer.

7. The package according to claim 6, further comprising at least one line of weakness positioned between the second and third adhesive layers configured to facilitate separation of the closure flap into a remainder portion having the third adhesive layer that remains attached to the front panel and a moveable portion having the first and second adhesive layers.

8. The package according to any of claims 1-7, wherein the first and second adhesive layers are parallel.

9. The package according to any of claims 6 and 7 wherein the first, second and third layers are parallel.

10. The package according to any one of claims 1-9, wherein the second adhesive layer is a pressure sensitive material.

11. The package according to any one of claims 1-10, in combination with a food product in the interior of the package.

12. A method of forming the package of any one of claims 1-11, the method comprising:
directing a first web of material in a machine direction;
placing at least one food product onto the first web of material;
folding opposing longitudinal edges of the first web of material inward over adjacent portions of the first web of material and around the food product and bringing the opposing longitudinal edges of the first web of material toward each other to a position where folded inward opposing longitudinal edges of the first web of material are offset from a central longitudinal axis of the first web of material such that a gap is formed between the folded inward opposing longitudinal edges of the first web of material;
applying a second web of material including at least the first and second adhesive layers to the first web of material such that the first adhesive layer non-removably attaches to the first web of material in the gap between the folded inward opposing longitudinal edges and the second adhesive layer removably attaches to a folded over portion of the first web of material proximate the folded inward opposing longitudinal edges of the first web of material;
forming the pair of end seals; and
separating the package from a remainder of the first web of material and the second web of material.

13. The method according to claim 12, wherein the second web of material includes the third adhesive layer.

14. The method according to claim 13, wherein the method further comprising the step of providing at least one line of weakness positioned between the second and third adhesive layers configured to facilitate separation of the closure flap into the remainder portion having the third adhesive layer that remains attached to the front panel and the moveable portion having the first and second adhesive layers.
